(19) United States
(12) Patent Application Publication
(10) Pub. No.: US 2014/0012529 A1
(43) Pub. Date: Jan. 9, 2014

(54) MOBILE TERMINAL CAPABLE OF MEASURING ALTITUDE AND ALTITUDE MEASUREMENT METHOD USING THE SAME

(71) Applicants: KOREA INSTITUTE OF SCIENCE AND TECHNOLOGY, (US); ELECTRONICS AND TELECOMMUNICATIONS RESEARCH INSTITUTE, (US)

(72) Inventors: Taik Jin LEE, Seoul (KR); Jae Hun Kim, Seoul (KR); Seok Lee, Seoul (KR); Hyuk Jae Lee, Gyeonggi-do (KR); Jung Ho Lee, Seoul (KR); Youngsu Cho, Daejeon (KR); Sangjoon Park, Daejeon (KR); Beom Ju Shin, Seoul (KR); Chulki Kim, Gangwon-do (KR)

(73) Assignees: ELECTRONICS AND TELECOMMUNICATIONS RESEARCH INSTITUTE, Daejeon (KR); KOREA INSTITUTE OF SCIENCE AND TECHNOLOGY, Seoul (KR)

(21) Appl. No.: 13/842,728

(22) Filed: Mar. 15, 2013

(30) Foreign Application Priority Data
Jul. 5, 2012 (KR) 10-2012-0073903

(51) Int. Cl. G01C 5/06

(52) U.S. Cl. CPC G01C 5/06
USPC 702/94

(57) ABSTRACT

The present invention relates to a mobile terminal capable of measuring an altitude and an altitude measurement method using the mobile terminal. The mobile terminal capable of measuring an altitude includes a barometric pressure information reception unit for receiving barometric pressure information, a barometric pressure correction unit for calculating a bias barometric pressure using the barometric pressure information received by the barometric pressure information reception unit, and a barometric pressure sensor for outputting a corrected barometric pressure to which the bias barometric pressure is applied.

### BACKGROUND OF THE INVENTION

1. Field of the Invention

The present invention relates, in general, to a mobile terminal capable of measuring an altitude and an altitude measurement method using the mobile terminal and, more particularly, to a mobile terminal capable of measuring an altitude and an altitude measurement method using the mobile terminal, which can provide accurate altitude information of a terminal user using a barometric pressure sensor mounted in the mobile terminal.

2. Description of the Related Art

Mobile communication devices, including recently developed smart phones, are each equipped with a Global Positioning System (GPS) receiver. GPS-based services are provided in the form of various types of applications executed using a location determination function, a current location transmission function, and location-based functions based on GPS technology.

Typical GPS-based services are provided in such a way as to determine location information within an allowable error range by receiving GPS information about a current location through a GPS receiver contained in a mobile terminal, to transmit such location information using a function included in the mobile terminal, and to limitedly track the location of the mobile terminal.

However, there is a disadvantage in that the location of the mobile terminal based on GPS information is mainly indicated by a two-dimensional (2D) location, that is, only by the latitude and longitude of a place at which the mobile terminal is currently located, and the location of an altitude can be neither indicated nor tracked.

Meanwhile, in modern urban society, the number of high-rise buildings is gradually increasing, and the percentage of people who work or live in high-rise buildings is also increasing. Particularly in Korea, the percentage of people who live in apartments is gradually increasing. When a location is determined based on current GPS information, it is impossible to receive GPS information in an indoor area, so the determination of a location is difficult, or a location different from the current location is indicated, and the determination of a location in a high-rise building is impossible. Accordingly, methods enabling a location to be estimated using altitude information have been presented.

However, there have been problems pointed out that make it difficult for mobile terminal users in such an environment to determine an accurate location using only 2D location information when determining or transmitting their locations within a high-rise building, particularly when an emergency evacuation situation, such as a fire or a terror, occurs and the users must transmit their location information or request location tracking.

That is, when persons placed in an evacuation situation are respectively located on the second floor and the 13th floor of a building, current technology makes it possible to receive only GPS information corresponding to the same location, so that unless evacuees request rescue from an area outside the high-rise building, it is difficult to determine an accurate height. As a result, there is a disadvantage in that a search operation cannot be specified, thus causing rescue operations to be inevitably limited.

### SUMMARY OF THE INVENTION

Accordingly, the present invention has been made keeping in mind the above disadvantages and problems pointed out in the conventional mobile terminal capable of receiving GPS information, and an object of the present invention is to provide a mobile terminal capable of measuring an altitude and an altitude measurement method using the mobile terminal, wherein a barometric pressure sensor is mounted in the mobile terminal to simultaneously provide location information and accurate altitude information based on the reception of GPS information, thus enabling the three-dimensional (3D) location information of the mobile terminal to be provided.

Another object of the present invention is to provide a mobile terminal capable of measuring an altitude and an altitude measurement method using the mobile terminal, which calibrate a barometric pressure sensor contained in the mobile terminal either using a sea-level pressure, or using reference barometric pressure information and altitude information provided by a barometer, and can estimate the altitude information of the mobile terminal based on the barometric pressure of the calibrated barometric pressure sensor.

A further object of the present invention is to provide a mobile terminal capable of measuring an altitude and an altitude measurement method using the mobile terminal, which combine the digital map data information of a building with altitude information measured by a calibrated barometric pressure sensor, thus enabling a floor on which the mobile terminal is located to be measured and pinpointed.

In order to accomplish the above objects, the present invention provides a mobile terminal capable of measuring an altitude, including a barometric pressure information reception unit for receiving barometric pressure information; a barometric pressure correction unit for calculating a bias barometric pressure using the barometric pressure information received by the barometric pressure information reception unit; and a barometric pressure sensor for outputting a corrected barometric pressure to which the bias barometric pressure is applied.

Further, in order to accomplish the above objects, the present invention provides a mobile terminal capable of measuring an altitude, including a barometric pressure information reception unit for receiving barometric pressure information; a barometric pressure sensor for outputting a corrected barometric pressure to which a bias barometric pressure is applied; and an altitude measurement unit for measuring an altitude of a current location using the corrected barometric pressure of the barometric pressure sensor and the barometric pressure information.

Furthermore, in order to accomplish the above objects, the present invention provides an altitude measurement method using a mobile terminal, including a) receiving a sea-level pressure by a barometric pressure information reception unit; b) measuring an actual barometric pressure using the sea-level pressure and altitude information; c) calculating a bias barometric pressure by subtracting a barometric pressure measured by a barometric pressure sensor from the actual barometric pressure; and d) calibrating the barometric pressure sensor by applying the bias barometric pressure to the barometric pressure sensor.

Furthermore, in order to accomplish the above objects, the present invention provides an altitude measurement method using a mobile terminal, including a) receiving a sea-level pressure by a barometric pressure information reception unit; b) measuring a corrected barometric pressure of a calibrated barometric pressure sensor; c) measuring an altitude of the mobile terminal using the sea-level pressure and the corrected barometric pressure of the barometric pressure sensor; and d) combining information about the altitude with map data information, and then pinpointing a floor on which the mobile terminal is located.

### BRIEF DESCRIPTION OF THE DRAWINGS

FIG. 1 is a configuration diagram of a mobile terminal capable of measuring an altitude according to the present invention;

FIG. 2 is a flowchart showing the calibration procedure of a barometric pressure sensor employed in the mobile terminal according to the present invention;

FIG. 3 is a flowchart showing an altitude measurement process using the mobile terminal according to the present invention; and

FIG. 4 is a graph showing the results of the measurement of the actual location of a mobile terminal user.

### DESCRIPTION OF THE PREFERRED EMBODIMENTS

Hereinafter, operations and effects of a mobile terminal capable of measuring an altitude and an altitude measurement method using the mobile terminal according to the present invention, together with technical configuration for the objects of the present invention, will be more clearly understood from the following detailed description taken in conjunction with the accompanying drawings which show preferred embodiments of the present invention.

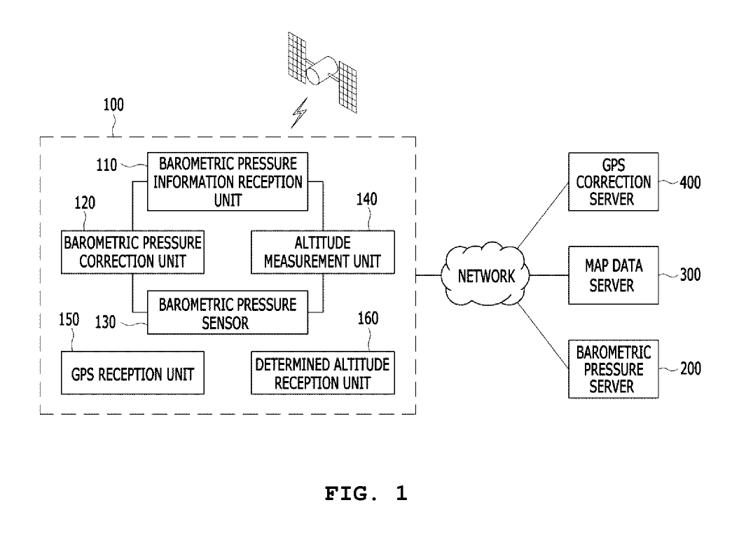

FIG. 1 is a configuration diagram showing a mobile terminal capable of measuring an altitude according to the present invention. As shown in the drawing, a mobile terminal 100 capable of measuring an altitude according to the present invention is connected to a wireless communication means over a network, may include a barometric pressure information reception unit 110 for receiving barometric pressure information over the network, a barometric pressure correction unit 120 for calculating a bias barometric pressure using the received barometric pressure information and altitude information, and a barometric pressure sensor 130 for outputting a corrected barometric pressure to which the bias barometric pressure is applied.

The mobile terminal 100 may further include an altitude measurement unit 140 for measuring the altitude of a current location using the corrected barometric pressure of the barometric pressure sensor 130 and the barometric pressure information received from the barometric pressure information reception unit 110.

The mobile terminal 100 may further include a GPS reception unit 150 for receiving latitude information, longitude information, and altitude information from a GPS satellite, and a determined altitude reception unit 160 for receiving latitude information, longitude information, and altitude information of a specific location, in addition to information transmitted from the GPS satellite.

In this case, the mobile terminal 100 according to the present invention can be connected to a barometric pressure server 200 for providing reference barometric pressure information over the network, a map data server 300 for providing the floor height and the number of floors of a building, and a GPS correction server 400 for providing a correction coefficient for errors in altitude information provided through the GPS satellite.

The barometric pressure information reception unit 110 of the mobile terminal 100 receives a sea-level pressure provided by a national official organization, such as the Meteorological Administration, over the network. The barometric pressure information reception unit 110 may provide information based on current location information represented by latitude and longitude received by the GPS reception unit 150 contained in the mobile terminal 100 or may provide a sea-level pressure for the location of the mobile terminal 100 that can be detected over the network, for example, a predetermined area around the mobile terminal 100 based on information about a cell that can be covered by a mobile communication base station. Further, the barometric pressure information reception unit 110 can receive reference barometric pressure information and reference altitude information about an area around the mobile terminal 100 through the barometric pressure server 200 operating in conjunction with a reference barometer. The sea-level pressure of an area in which the mobile terminal is currently located can be calculated using the reference barometric pressure information and the reference altitude information provided by the barometric pressure server 200.

In this case, the sea-level pressure denotes a pressure indicating a barometric pressure at a mean sea level, and can be defined by a barometric pressure at the mean sea level obtained by performing the reduction of a barometric pressure observed at a specific observation point to a mean sea level. Such a sea-level pressure can be acquired using barometric pressure information or the like provided by the Meteorological Administration or a private institution, and barometric pressure information of a specific area can be provided by the database (DB) server of a mobile communication company. In addition to the sea-level pressure, reference barometric pressure information using a barometer and reference altitude information can also be provided by the barometric pressure server 200 provided by a private institution or a mobile communication company. Further, reference barometric pressure information and reference altitude information of a specific area can be provided in the form of a table via the mobile terminal 100. Alternatively, via smart phones, which have recently been widely popularized, such information can be provided in the form of an application capable of obtaining reference barometric pressure information and reference altitude information for individual areas, such as principal urban areas in a city, tourist attractions, and a city/country/district. In this case, when the reference barometric pressure information and the reference altitude information are stored in the mobile terminal 100, the calculation of a sea-level pressure can be performed without having to receive separate reference barometric pressure information and reference altitude information over the network.

Further, the barometric pressure correction unit 120 can calibrate the barometric pressure sensor 130 by using the sea-level pressure which is received from the barometric pressure information reception unit 110 or a sea-level pressure which is calculated using both the reference barometric pressure information and the reference altitude information received from the barometric pressure server 200, and current location-based altitude information.

In greater detail, the calibration of the barometric pressure sensor 130 is performed using the sea-level pressure received from the barometric pressure information reception unit 110 or calculated using both the reference barometric pressure information and the reference altitude information, and the current location-based altitude information of the mobile terminal 100. In this case, the sea-level pressure can be received through the above-described barometric pressure information reception unit 110, and the altitude information can be received simultaneously with longitude and latitude information from the GPS satellite through the GPS reception unit 150 of the mobile terminal 100. The actual barometric pressure of an area in which the mobile terminal 100 is located can be calculated using both the sea-level pressure and the altitude information.

Here, the altitude information received by the mobile terminal 100 can be obtained such that, in addition to altitude information received from the GPS satellite, determined altitude information of a specific area can be received from the determined altitude reception unit 160 or such that altitude information of a specific area stored in the mobile terminal 100 itself can be obtained. For example, the determined altitude information of the specific area can be obtained in such a way that a terminal for storing altitude information, as well as latitude and longitude information, is separately installed on the first floor of a building, and the mobile terminal 100 can obtain the altitude information of the terminal via Near Field Communication (NFC) or Radio Frequency Identification (RFID) through the determined altitude reception unit 160. As the information stored in the mobile terminal 100, the latitude, longitude, and altitude information of a representative area, a representative building, etc. can be obtained in the form of a table or an application, similar to that of the above-described reference barometric pressure information.

Furthermore, a bias barometric pressure is calculated depending on a difference obtained by subtracting the barometric pressure measured by the barometric pressure sensor 130 from the real barometric pressure of the corresponding area measured using both the sea-level pressure and the altitude information. In this case, the bias barometric pressure is applied to the barometric pressure measured by the barometric pressure sensor 130, so that the calibration of the barometric pressure sensor 130 is performed.

The reason for calibrating the barometric pressure sensor 130 is that, in the case of the barometric pressure sensor 130 contained in the mobile terminal 100, different barometric pressure values are inevitably output from barometric pressure sensors contained in different terminals under identical time and place conditions, and so it is difficult to measure the absolute altitude of the surrounding area, in which the mobile terminal 100 is located, using only the barometric pressure information measured by the barometric pressure sensor 130. Therefore, it is intended to calibrate the barometric pressure sensor 130 by compensating for the barometric pressure measured by the barometric pressure sensor 130 contained in the mobile terminal 100 with the bias barometric pressure calculated using the sea-level pressure, and to calculate an absolute altitude at which the mobile terminal 100 is actually located by using the corrected barometric pressure measured by the calibrated barometric pressure sensor 130.

Furthermore, since the mobile terminal 100 may receive altitude information, which is less accurate than the latitude and longitude information, through the GPS reception unit 150, upon receiving GPS altitude information from the GPS satellite, GPS correction information about the corresponding altitude information is received through the GPS correction server 400 connected to the network, thus enabling any errors in GPS altitude information to be corrected. The barometric pressure sensor 130 can be more precisely calibrated based on the GPS correction information. When altitude information is tracked as will be described later, more accurate altitude information can be estimated.

In this way, after the barometric pressure sensor 130 contained in the mobile terminal 100 has been calibrated, an altitude at which the mobile terminal 100 is located is calculated using the corrected barometric pressure measured by the calibrated barometric pressure sensor 130 and the sea-level pressure received through the barometric pressure information reception unit 110. The calculation of the altitude of the mobile terminal 100 can be performed by the altitude measurement unit 140.

In this case, as the sea-level pressure required to calculate the absolute altitude of the mobile terminal 100, either the sea-level pressure received from the Meteorological Administration or the like through the barometric pressure information reception unit 110 or the sea-level pressure calculated using both the reference barometric pressure information and the reference altitude information received from the barometric pressure server 200 through the barometric pressure information reception unit 110 over the network, can be used. In addition, as described above, the sea-level pressure can be calculated by using reference barometric pressure information and reference altitude information which are received from a barometer pressure-related DB server provided by a private institution or a mobile communication company, or by using reference barometric pressure information and reference altitude information which are stored in the mobile terminal 100 itself, and can then be used. Further, the reference barometric pressure information is not separately converted into a sea-level pressure and is applied to the altitude measurement unit 140, so that the altitude can be calculated by a computation between the reference barometric pressure and the corrected barometric pressure of the barometric pressure sensor 130.

In this case, the altitude information of the mobile terminal 100 calculated by the altitude measurement unit 140 is combined with the information about the building, received from the map data server 300 connected to the mobile terminal 100 over the network, and then the altitude information can be measured as information about the floor on which the mobile terminal is located. This floor information can be output via the display of the mobile terminal 100.

Here, the information about each building provided by the map data server 300 may be 3D map information about the building that includes the number of floors of the building, the height between floors (inter-floor height), and the height of a first floor when the height of the first floor is different from that of other floors.

Further, when the map data server 300 cannot be connected to the network or when there is no information stored in the map data server 300, the average height between floors (average inter-floor height) (about 2.5˜3 m) of individual buildings can be used to calculate floor information corresponding to altitude information.

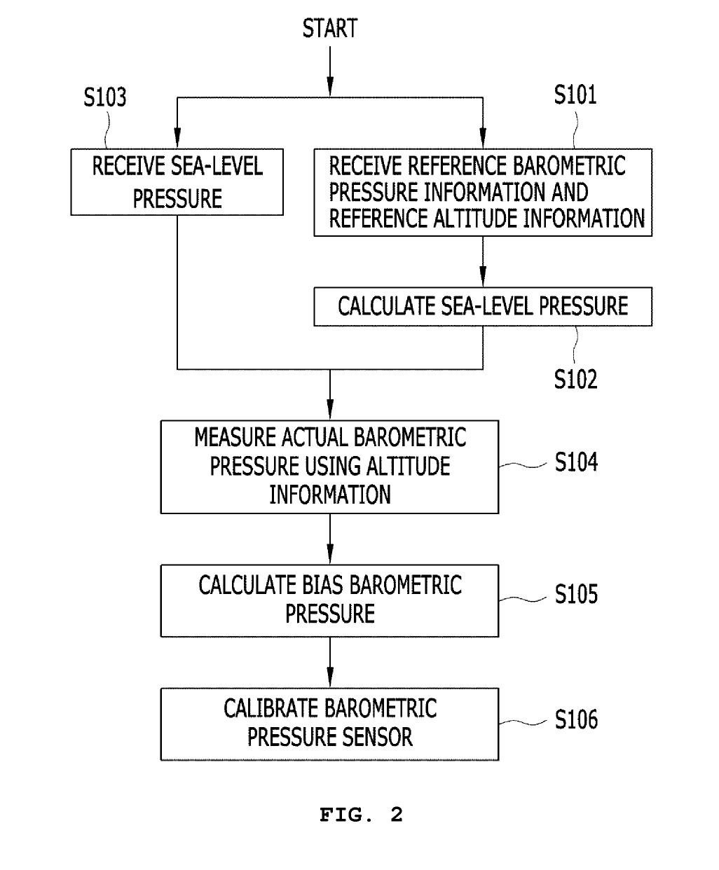

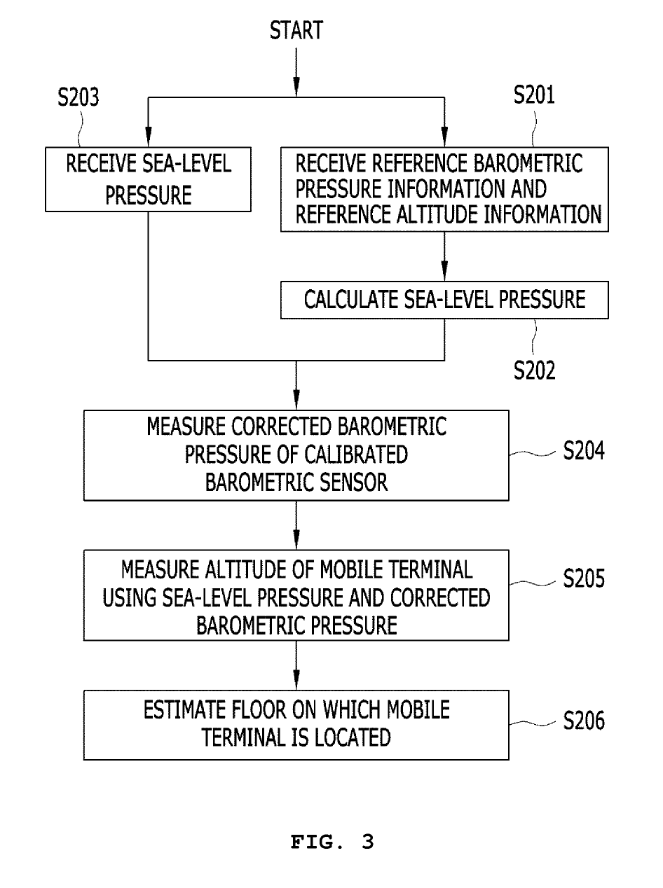

The calibration procedure of the barometric pressure sensor contained in the mobile terminal capable of measuring an altitude, which has the above configuration, and an altitude measurement process using the mobile terminal will be described in detail with reference to FIGS. 2 and 3 in which FIG. 1 is considered.

FIG. 2 is a flowchart showing the calibration procedure of the barometric pressure sensor employed in the mobile terminal according to the present invention.

As shown in FIG. 2, reference barometric pressure information and reference altitude information are received by the barometric pressure information reception unit 110 at step S101. A sea-level pressure is calculated using both the received reference barometric pressure information and reference altitude information at step S102. Here, the reference barometric pressure information and the reference altitude information can be received by the barometric pressure information reception unit 110 from the barometric pressure server 200, which is operated in conjunction with either the barometer of the Meteorological Administration or a private institution, or the DB server of a mobile communication company, over the network. The reference barometric pressure information and the reference altitude information denote the barometric pressure information and altitude information of the surrounding area in which the mobile terminal 100 is located. As described above, the barometric pressure and altitude information within the range of a cell of a base station to which the mobile terminal 100 is connected may be provided, or barometric pressure and altitude information at a location based on the latitude and longitude of GPS information may be provided.

In this case, the sea-level pressure using the reference barometric pressure information and the reference altitude information can be calculated by the following Equation (1):

$${p}_{0} ( t ) = \frac{{p}_{r} ( t )}{{( 1 - \frac{{h}_{r} ( t )}{a} )}^{b}} \qquad ( 1 )$$

where p₀(t) denotes a sea-level pressure, pᵣ(t) denotes a reference barometric pressure, hᵣ(t) denotes a reference altitude, and a and b denote scale factors.

Meanwhile, the sea-level pressure calculated by Equation (1) is information measured and stored by an official organization, such as the Meteorological Administration, and can be directly received by the barometric pressure information reception unit 110 of the mobile terminal 100 over the network at step S103. In this case, the sea-level pressure calculation step using Equation (1) can be omitted.

Next, an actual barometric pressure is measured using the sea-level pressure calculated by Equation (1) or the sea-level pressure received by the barometric pressure information reception unit 110, and the altitude information, at step S104. The altitude information is the actual altitude of the surrounding area in which the mobile terminal 100 is located, and can be received from the GPS satellite through the GPS reception unit 150. Further, when the information of the GPS satellite cannot be received, or when the GPS reception unit 150 is not contained in the mobile terminal 100, the determined altitude information of a specific area can also be received using Near Field Communication (NFC) or RFID through the determined altitude reception unit 160. Furthermore, the latitude, longitude, and altitude information of a representative area, a representative building, etc. can be obtained in the form of a table or an application using the information stored in the mobile terminal 100.

The actual barometric pressure is calculated from altitude information obtained using various schemes including GPS information. The actual barometric pressure is barometric pressure information separate from the barometric pressure measured by the barometric pressure sensor 130 contained in the mobile terminal 100, and is barometric pressure information that can be theoretically calculated together with the sea-level pressure using the actual altitude information of the mobile terminal. Here, the actual barometric pressure can be calculated by the following Equation (2):

$${p}_{u} ( t ) = {p}_{0} ( t ) \cdot {( 1 - \frac{{h}_{u} ( t )}{a} )}^{b} \qquad ( 2 )$$

where pᵤ(t) denotes an actual barometric pressure, hᵤ(t) denotes an actual altitude, p₀(t) denotes a sea-level pressure, and a and b denote scale factors.

In this case, when altitude information is obtained from the GPS satellite, the GPS correction information of the GPS correction server 400 is further received and used to correct any errors in the GPS altitude information, and thus more accurate altitude information can be obtained.

Next, a bias barometric pressure is calculated by subtracting the pressure measured by the barometric pressure sensor 130 from the theoretical actual barometric pressure, calculated at the previous step, at step S105. The bias barometric pressure is a barometric pressure used to compensate for barometric pressures differently measured by the barometric pressure sensor 130, and is added to or subtracted from the barometric pressures measured by the barometric pressure sensor 130, so that corrected barometric pressure information can be extracted through the barometric pressure sensor 130, thus enabling an absolute barometric pressure corresponding to the sea-level pressure to be calculated.

Next, the barometric pressure sensor 130 is calibrated by applying the calculated bias barometric pressure to the barometric pressure sensor 130 at step S106. The corrected barometric pressure measured by the calibrated barometric pressure sensor 130 can be used as base data required to measure an absolute altitude.

In this case, the bias barometric pressure can be calculated by the following Equation (3):

pᵤ(t)=pₘ(t)+p_{b}

p_{b}=pᵤ(t)−pₘ(t) (3)

where pₘ(t) denotes a barometric pressure measured by the barometric pressure sensor, p_{b} denotes a bias barometric pressure, and pᵤ(t) denotes an actual barometric pressure.

The calibration of the barometric pressure sensor 130 is conducted by performing a calibration procedure once as the sea-level pressure is used on a ground surface. Thereafter, a repetitive calibration procedure is not required, and a repetitive altitude measurement can be performed via the one calibration procedure of the barometric pressure sensor.

FIG. 3 is a flowchart showing an altitude measurement process using the mobile terminal according to the present invention.

As shown in FIG. 3, reference barometric pressure information and reference altitude information are received by the barometric pressure information reception unit 110 at step S201. A sea-level pressure is calculated using the received reference barometric pressure information and reference altitude information at step S202. In this case, the reference barometric pressure information and the reference altitude information can be obtained using the same method as that of the calibration procedure of the barometric pressure sensor, and the sea-level pressure can also be calculated using the same Equation, and thus a repetitive description will be omitted here.

Further, the sea-level pressure is information measured and stored by an official organization, such as the Meteorological Administration, and can be directly received by the barometric pressure information reception unit 110 of the mobile terminal 100 over the network at step S203. In this case, the sea-level pressure calculation step using the reference barometric pressure information and the reference altitude information can be omitted.

Next, the corrected barometric pressure of the calibrated barometric pressure sensor 130 is measured at step S204. The corrected barometric pressure measured by the calibrated barometric pressure sensor 130 is a barometric pressure to which the bias barometric pressure is applied to the above-described step of calibrating the barometric pressure sensor 130.

Next, the altitude of the mobile terminal is measured using the corrected barometric pressure of the barometric pressure sensor 130 and the sea-level pressure at step S205.

In this case, the altitude of the mobile terminal is an absolute altitude at which the mobile terminal is actually located with respect to the ground surface, depending on the corrected barometric pressure to which the bias barometric pressure is applied. The altitude information can be calculated by the following Equation (4):

$${h}_{u} ( t ) = a \cdot ( 1 - {( \frac{{p}_{u} ( t )}{{p}_{0} ( t )} )}^{\frac{1}{b}} ) \qquad ( 4 )$$

where hᵤ(t) denotes the absolute altitude of the mobile terminal, p₀(t) denotes a sea-level pressure, pᵤ(t) denotes a corrected barometric pressure, and a and b denote scale factors.

In this regard, the sea-level pressure applied to the above Equation is replaced with the stored barometric pressure information of a specific area, and then altitude information can be measured.

Thereafter, when the absolute altitude at which the mobile terminal is located is measured, the information stored in the map data server 300 connected to the mobile terminal over the network is combined with the altitude information, so that information about the floor on which the mobile terminal is located is extracted at step S206. Map data information relates to information about each building, the location of which can be detected based on latitude and longitude information. As map data information, 3D building information, such as the number of floors of each high-rise building, the inter-floor height of the building, and the height of the first floor of the building, can be mainly provided.

The altitude information-based floor measured using the map data information can be calculated by the following Equation (5):

$$L ( t ) = \frac{{h}_{u} ( t ) - {h}_{0}}{d} \qquad ( 5 )$$

where L(t) denotes a floor on which the mobile terminal is located, hᵤ(t) denotes altitude information, h₀ denotes the height of the first floor of the building, and d denotes an inter-floor height.

When the map data information cannot be provided or when only the overall height of the building and information about the inter-floor height are provided, that is, when incomplete information is provided, an inter-floor height of about 2.5˜3 m, which is the inter-floor height of a typical building, can be arbitrarily applied.

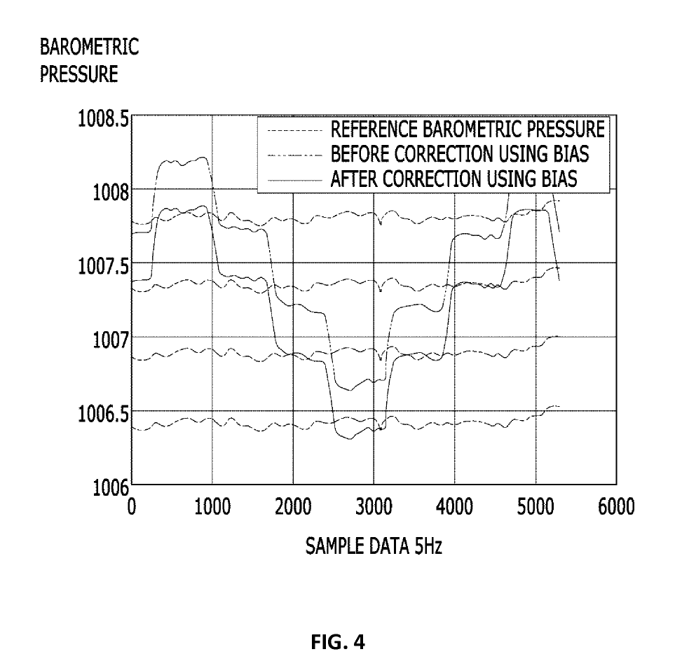

In this way, referring to the results of measuring the actual location of the mobile terminal user located in the corresponding building using the real-time accurate altitude information and map data information based on the barometric pressure measured and corrected by the barometric pressure sensor by means of a series of steps, it can be seen in the graph shown in FIG. 4 and the following Table 1 that an accurate altitude can be measured and an accurate floor can be pinpointed.

As shown in FIG. 4, if the barometric pressure sensor of the mobile terminal calculates a bias barometric pressure using the sea-level pressure and then a barometric pressure (colored in blue) measured by the barometric pressure sensor is corrected by applying the bias barometric pressure to the measured barometric pressure, the corrected barometric pressure (colored in red) can be calculated and output. When the actual altitude estimated by combining the corrected barometric pressure (colored in red) with map data information is measured as the altitude of Table 1. If a floor calculated at the estimated altitude is compared with the floor on which the mobile terminal user is actually located, it can be seen that the altitude location information of the mobile terminal user is exactly identical to the location information of the measured floor.

TABLE 1

| | Before | After | | |
|---|---|---|---|---|
| | barometric | barometric | | Actual |
| | pressure | pressure | Estimated | location/estimated |
| | correction | correction | altitude | results |
| 1^{st} floor | 1008.3 | 1007.9 | 49.2097 | 1^{st} floor/1^{st} floor |
| 2^{nd} floor | 1007.8 | 1007.4 | 53.3907 | 2^{nd} floor/2^{nd} floor |
| 3^{rd} floor | 1007.3 | 1006.9 | 57.5734 | 3^{rd} floor/3^{rd} floor |
| 4^{th} floor | 1006.8 | 1006.4 | 61.7578 | 4^{th} floor/4^{th} floor |

As described above, a mobile terminal capable of measuring an altitude and an altitude measurement method using the mobile terminal according to the present invention are advantageous in that a barometric pressure sensor is calibrated either using a sea-level pressure received through the mobile terminal or using reference barometric pressure information and the altitude information of GPS, and in that accurate information about a floor on which the mobile terminal is located within a high-rise building can be obtained by combining altitude information calculated using a barometric pressure measured by the calibrated barometric pressure sensor with 3D map data information.

Further, the present invention is configured such that accurate information about the altitude and the floor of a building on which a terminal user is located can be obtained or pinpointed using a mobile terminal containing a barometric pressure sensor. Accordingly, the present invention is advantageous in that it can be utilized for various fields using physical distribution, entertainment, navigation, advertising, social networking, etc., and in that, in addition to the various fields, mobile terminal users can be promptly and safely rescued in emergency situations, such as a fire or a terror, based on accurate information about an altitude and a floor within a building.

Although the preferred embodiments of the present invention have been disclosed for illustrative purposes, those skilled in the art will appreciate that various modifications, additions and substitutions are possible, without changing technical spirit or essential features of the present invention. Therefore, it should be noted that the above-described embodiments are not restrictive, but are exemplary from all aspects. For example, each component described as a single component can be distributed and implemented, and components described as distributed components can also be implemented in a combined form.

The scope of the present invention is defined by the accompanying claims rather than by the detailed description of the invention. Furthermore, all the changes or modifications derived from the meanings, scopes, and equivalents of the claims should be interpreted as being included in the scope of the present invention.

1. A mobile terminal capable of measuring an altitude, comprising:
a barometric pressure information reception unit for receiving barometric pressure information;
a barometric pressure correction unit for calculating a bias barometric pressure using the barometric pressure information received by the barometric pressure information reception unit; and
a barometric pressure sensor for outputting a corrected barometric pressure to which the bias barometric pressure is applied.

2. The mobile terminal of claim 1, further comprising:
a Global Positioning System (GPS) reception unit for receiving latitude, longitude, and altitude information from a GPS satellite; and
a determined altitude reception unit for receiving latitude, longitude, and altitude information of a specific location via Near Field Communication (NFC) or Radio Frequency Identification (RFID).

3. The mobile terminal of claim 2, wherein the barometric pressure information reception unit calculates a sea-level pressure by receiving reference barometric pressure information and reference altitude information from a barometric pressure server, or receives the sea-level pressure from the barometric pressure server.

4. The mobile terminal of claim 3, wherein the sea-level pressure is provided as location-based information received by the GPS reception unit or as barometric pressure information within a cell area covered by a base station connected to the mobile terminal.

5. The mobile terminal of claim 3, wherein the barometric pressure correction unit calculates the bias barometric pressure using the sea-level pressure and altitude information and calibrates the barometric pressure sensor.

6. The mobile terminal of claim 5, wherein the altitude information is obtained such that any one of altitude information received from a GPS satellite, previously stored altitude information of a specific location, and altitude information stored in the mobile terminal is obtained.

7. The mobile terminal of claim 1, wherein the mobile terminal further receives GPS correction information about altitude information through a GPS correction server connected to a network when the altitude information is received from a GPS satellite.

8. The mobile terminal of claim 1, wherein the mobile terminal performs wireless communication with a barometric pressure server for providing sea-level pressure or reference barometric pressure information over a network, a map data server for providing information about a floor height of a building and a number of floors of the building, and a GPS correction server for providing a correction coefficient for errors in altitude information provided through a GPS satellite.

9. A mobile terminal capable of measuring an altitude, comprising:
a barometric pressure information reception unit for receiving barometric pressure information;
a barometric pressure sensor for outputting a corrected barometric pressure to which a bias barometric pressure is applied; and
an altitude measurement unit for measuring an altitude of a current location using the corrected barometric pressure of the barometric pressure sensor and the barometric pressure information.

10. The mobile terminal of claim 9, further comprising a barometric pressure correction unit for calculating the bias barometric pressure using the barometric pressure information received by the barometric pressure information reception unit.

11. The mobile terminal of claim 9, wherein the barometric pressure information reception unit calculates a sea-level pressure by receiving reference barometric pressure information and reference altitude information from a barometric pressure server, or receives the sea-level pressure from the barometric pressure server.

12. The mobile terminal of claim 9, wherein the altitude information calculated by the altitude measurement unit is combined with building information received from a map data server connected over a network, and then information about a floor on which the mobile terminal is located is estimated.

13. The mobile terminal of claim 12, wherein the building information received from the map data server is provided such that one or more of information about a number of floors of each building, information about an inter-floor height of the building, and information about a height of a first floor of the building are provided.

14. An altitude measurement method using a mobile terminal, comprising:
a) receiving a sea-level pressure by a barometric pressure information reception unit;
b) measuring an actual barometric pressure using the sea-level pressure and altitude information;
c) calculating a bias barometric pressure by subtracting a barometric pressure measured by a barometric pressure sensor from the actual barometric pressure; and
d) calibrating the barometric pressure sensor by applying the bias barometric pressure to the barometric pressure sensor.

15. The altitude measurement method of claim 14, wherein a) is configured to calculate the sea-level pressure using reference barometric pressure information and reference altitude information received by the barometric pressure information reception unit.

16. The altitude measurement method of claim 15, wherein the sea-level pressure is calculated by the following equation:
$${p}_{0} ( t ) = \frac{{p}_{r} ( t )}{{( 1 - \frac{{h}_{r} ( t )}{a} )}^{b}}$$
where p₀(t) denotes a sea-level pressure, pᵣ(t) denotes a reference barometric pressure, hᵣ(t) denotes a reference altitude, and a and b denote scale factors.

17. The altitude measurement method of claim 14, wherein b) is configured to obtain any one of altitude information received from a Global Positioning System (GPS) satellite, previously stored altitude information of a specific location, and altitude information stored in the mobile terminal.

18. The altitude measurement method of claim 17, wherein the actual barometric pressure is calculated by the following equation:
$${p}_{u} ( t ) = {p}_{0} ( t ) \cdot {( 1 - \frac{{h}_{u} ( t )}{a} )}^{b}$$
where pᵤ(t) denotes an actual barometric pressure, hᵤ(t) denotes an actual altitude, p₀(t) denotes a sea-level pressure, and a and b denote scale factors.

19. The altitude measurement method of claim 14, wherein b) further comprises, if the altitude information is obtained from a GPS satellite, correcting the altitude information using GPS correction information of a GPS correction server.

20. The altitude measurement method of claim 14, wherein c) is configured to calculate the bias barometric pressure by the following equation:
pᵤ(t)=pₘ(t)+p_{b}
p_{b}=pᵤ(t)−pₘ(t)
where pₘ(t) denotes a barometric pressure measured by the barometric pressure sensor, p_{b} denotes a bias barometric pressure, and pᵤ(t) denotes an actual barometric pressure.

21. An altitude measurement method using a mobile terminal, comprising:
a) receiving a sea-level pressure by a barometric pressure information reception unit;
b) measuring a corrected barometric pressure of a calibrated barometric pressure sensor;
c) measuring an altitude of the mobile terminal using the sea-level pressure and the corrected barometric pressure of the barometric pressure sensor; and
d) combining information about the altitude with map data information, and then pinpointing a floor on which the mobile terminal is located.

22. The altitude measurement method of claim 21, further comprising, before b):
measuring an actual barometer pressure using the sea-level pressure and the altitude information;
calculating a bias barometric pressure by subtracting a barometric pressure measured by the barometric pressure sensor from the actual barometric pressure; and
calibrating the barometric pressure sensor by applying the bias barometric pressure to the barometric pressure sensor.

23. The altitude measurement method of claim 22, wherein a) is configured to calculate the sea-level pressure using reference barometric pressure information and reference altitude information received by the barometric pressure information reception unit.

24. The altitude measurement method of claim 21, wherein c) is configured to calculate the altitude using the following equation:
$${h}_{u} ( t ) = a \cdot ( 1 - {( \frac{{p}_{u} ( t )}{{p}_{0} ( t )} )}^{\frac{1}{b}} )$$
where hᵤ(t) denotes an absolute altitude of the mobile terminal, p₀(t) denotes a sea-level pressure, pᵤ(t) denotes a corrected barometric pressure, and a and b denote scale factors.

25. The altitude measurement method of claim 21, wherein d) is configured to calculate floor information extracted using the map data information by the following equation:
$$L ( t ) = \frac{{h}_{u} ( t ) - {h}_{0}}{d}$$
where L(t) denotes a floor on which the mobile terminal is located, hᵤ(t) denotes altitude information, h₀ denotes a height of a first floor of a building, and d denotes an inter-floor height.

26. The mobile terminal of claim 1, wherein the barometric pressure correction unit calculates the bias barometric pressure using the sea-level pressure and altitude information and calibrates the barometric pressure sensor.
